(19) United States
(12) Patent Application Publication
(10) Pub. No.: US 2001/0040169 A1
(43) Pub. Date: Nov. 15, 2001

(54) Dispenser for supplying a toilet seat cover sheet

(76) Inventor: Masachika Kohno, Kyoto (JP)

Correspondence Address: Michael D. Bednarek, SHAW PITTMAN, 1650 Tysons Boulevard, McLean, VA, 22102-4859, US

(21) Appl. No.: 09/749,404

(22) Filed: Dec. 28, 2000

(30) Foreign Application Priority Data
Dec. 28, 1999 (JP) 11-375296
Jul. 25, 2000 (JP) 2000-223272

(51) Int. Cl. G07F 11/72

(52) U.S. Cl. 221/30

(57) ABSTRACT

A toilet seat cover sheet dispenser includes a roll of an elongated sheet, and a case for rotatably housing the sheet roll. The case includes a substantially cylindrical inner shell for rotatably accommodating the sheet roll, and a substantially cylindrical outer sheath rotatably fitted around the inner shell. The inner shell is formed with a narrower slit, whereas the outer sheath being formed with a wider slit. The outer sheath is rotatable relative to the inner shell for bringing the wider slit of the outer sheath into and out of alignment with the narrower slit of the inner shell.

### BACKGROUND OF THE INVENTION

1. Field of the invention

The present invention relates to a toilet seat cover sheet used to prevent the user from coming into direct contact with the seat which may be contaminated by repeated use. It also relates to a roll of a toilet seat cover sheet and a case which may be incorporated into such a dispenser.

2. Description of the Related Art

In using toilet away from home (at a hotel or a restaurant for example), the user may wish to avoid coming into direct contact with the toilet seat which may be contaminated. For this purpose, use may be made of a sheet for covering a toilet seat, as disclosed in JP-U-63-150597 and JP-U-60-63293, for example. Such a prior-art cover sheet is made of water-soluble paper or resin and shaped into a ring or a horse shoe. Before use, the cover sheet is folded into a smaller size for the convenience of carriage (in a bag or a pocket for example) In use, the sheet is spread out to be set on a toilet seat before the user sits on the seat.

However, the prior art toilet seat cover sheet has a relatively large thickness due to multiple folds for carriage. Therefore, when a large number of toilet seat cover sheets needs to be carried for a long trip for example, they are considerably bulky as a whole. Further, a folded cover sheet or sheets may unexpectedly spread out in a bag. Thus, the prior art toilet seat cover sheet is inconvenient for carriage.

Moreover, since the prior art toilet seat cover sheet needs to be folded before use, traces of folds will remain even when spread out for use. Therefore, it is often difficult to bring the cover sheet into entire contact with the surface of a toilet seat, so that the sheet may displace on the seat while the remaining traces of folds may give uncomfortable feel to the user.

### SUMMARY OF THE INVENTION

It is, therefore, an object of the present invention to provide a toilet seat cover sheet dispenser which is convenient for handling and carrying.

Another object of the present invention is to provide a toilet seat cover sheet which may be advantageously incorporated into such a dispenser.

A further object of the present invention is to provide a case which may be advantageously used for providing such a dispenser.

In accordance with a first aspect of the present invention, a toilet seat cover sheet dispenser comprises a roll of an elongated sheet, and a case for rotatably housing the sheet roll, wherein the case is formed with a slit for taking out the sheet.

Preferably, the case may include at least one end cap which is removable for inserting the sheet roll axially into the case. More particularly, the case may include a substantially cylindrical shell formed with the slit which extends over an entire length of the shell, and a pair of end caps each press-fitted on a respective end of the shell, wherein each end cap is removable from the respective end of the shell for inserting the sheet roll axially into the case.

Preferably, the sheet roll may include a core shaft axially projecting beyond the roll. In this case, each end cap has an inner annular wall rotatably receiving the core shaft of the sheet roll, and an outer annular wall press-fitted on the respective end of the shell.

Preferably, the case may further include a substantially cylindrical outer sheath rotatably fitted around the shell between the pair of end caps, and the outer sheath may be formed with a slit which is wider than the slit of the shell.

In a preferred embodiment, the case includes a substantially cylindrical inner shell for rotatably accommodating the sheet roll, and a substantially cylindrical outer sheath rotatably fitted around the inner shell. The inner shell may be formed with a narrower slit, whereas the outer sheath may be formed with awider slit. The outer sheath may be rotatable relative to the inner shell for bringing the wider slit of the outer sheath into and out of alignment with the narrower slit of the inner shell.

Preferably, the slit may be provided with a cutting blade for cutting the sheet.

Preferably, the sheet may be made of a water-soluble material, particularly, water-soluble resin.

Preferably, the sheet may be embossed to have an obverse surface formed with projections, and a reverse surface formed with depressions. Further, the sheet may be formed with a plurality of perforated tear-off lines at a predetermined pitch longitudinally of the sheet.

According to a second aspect of the present invention, there is provided a roll of an elongated toilet seat cover sheet, wherein the sheet is embossed to have an obverse surface formed with projections, and a reverse surface formed with depressions.

Preferably, the sheet may be made of a water-soluble material, particularly water-soluble resin.

Preferably, the sheet may be formed with a plurality of perforated tear-off lines at a predetermined pitch longitudinally of the sheet.

The sheet roll may further include a core shaft projecting axially beyond the sheet roll.

According to a third aspect of the present invention, there is provided a case for accommodating a roll of a sheet, comprising: a substantially cylindrical inner shell for rotatably accommodating the sheet roll, and a substantially cylindrical outer sheath rotatably fitted around the inner shell. The inner shell is formed with a narrower slit, whereas the outer sheath is formed with a wider slit. The outer sheath is rotatable relative to the inner shell for bringing the wider slit of the outer sheath into and out of alignment with the narrower slit of the inner shell.

The case may further comprise at least one end cap (preferably a pair of end caps) attached to an end (both ends, respectively) of the inner shell. The end cap (each end cap) may be removed from the end of the inner shell for inserting the sheet roll axially into the case. The outer sheath may be rotatably fitted around the inner shell between the pair of end caps. Further, if the sheet roll includes a core shaft axially projecting beyond the roll, the end cap may have an inner annular wall rotatably receiving the core shaft of the sheet roll, and an outer annular wall press-fitted on the respective end of the shell.

Preferably, the wider slit of the outer sheath may be provided with a cutting blade for cutting the sheet.

Other features and advantages of the present invention will become clearer from the detailed description given below with reference to the accompanying drawings.

### BRIEF DESCRIPTION OF THE DRAWINGS

FIG. 1 is a perspective view showing a dispenser for supplying a toilet seat cover sheet embodying the present invention.

FIG. 2 is a sectional view taken along lines II-II in FIG. 1 for showing the same sheet dispenser in a sheet pay-out condition.

FIG. 3 is a sectional view taken along lines III-III in FIG. 1.

FIG. 4 is an exploded perspective view of the same sheet dispenser.

FIG. 5 is an enlarged perspective view showing a toilet seat cover sheet housed in the same dispenser.

FIG. 6 is a sectional view similar to FIG. 3 but shows the same sheet dispenser in a sheet pay-out preventing condition.

FIGS. 7 and 8 are perspective views showing how the sheet dispenser is used to cover a toilet seat.

FIG. 9 is a perspective view showing another toilet seat cover sheet dispenser embodying the present invention.

### DETAILED DESCRIPTION OF THE PREFERRED EMBODIMENTS

A preferred embodiment of the present invention will be described below in detail with reference to the accompanying drawings.

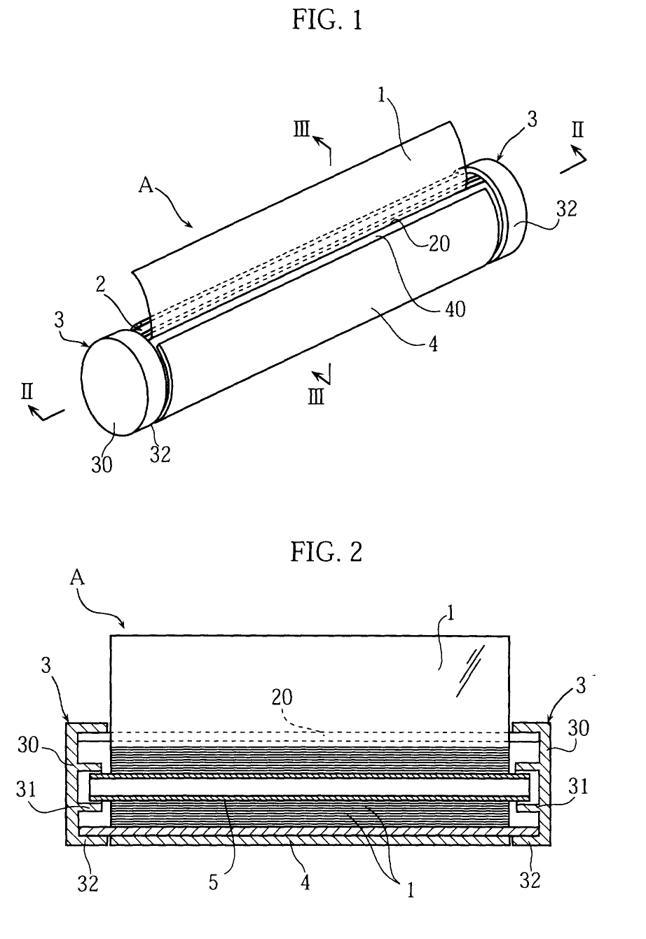

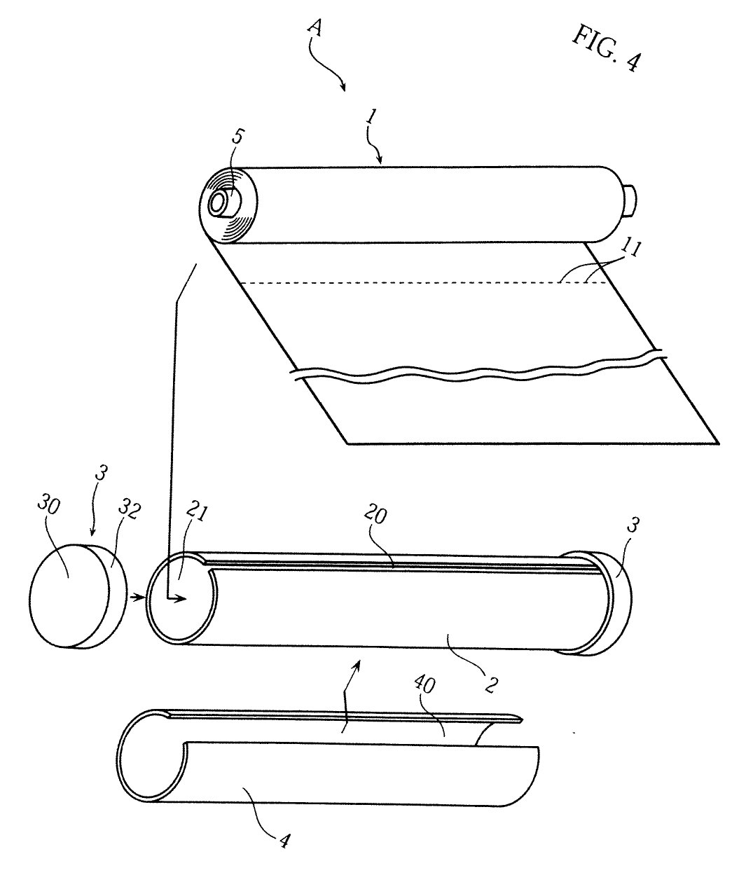

FIGS. 1 through 5 illustrate an example of dispenser for supplying a toilet seat cover sheet in accordance with the present invention. As best shown in FIG. 4, the sheet dispenser, generally represented by reference sign A, comprises a roll of cover sheet 1, an inner shell 2, end caps 3 and an outer sheath 4. In the illustrated embodiment, the inner shell 2, the end caps 3 and the outer sheath 4 form a case for the sheet roll 1.

The sheet roll 1 is provided by winding a continuous sheet (elongated strip) around a core or shaft 5 which may be a paper tube for example. However, use may be made of a sheet roll without a core. The sheet may be 10˜20 cm in width, 10˜90 m in length and 20˜30 μm min thickness, for example. The sheet maybe formed of water-soluble resin such as polyvinyl alcohol. The sheet maybe formed with a plurality of perforated tear-off lines 11 extending width wise of the sheet and arranged at a predetermined pitch of e.g. 50 cm longitudinally of the sheet.

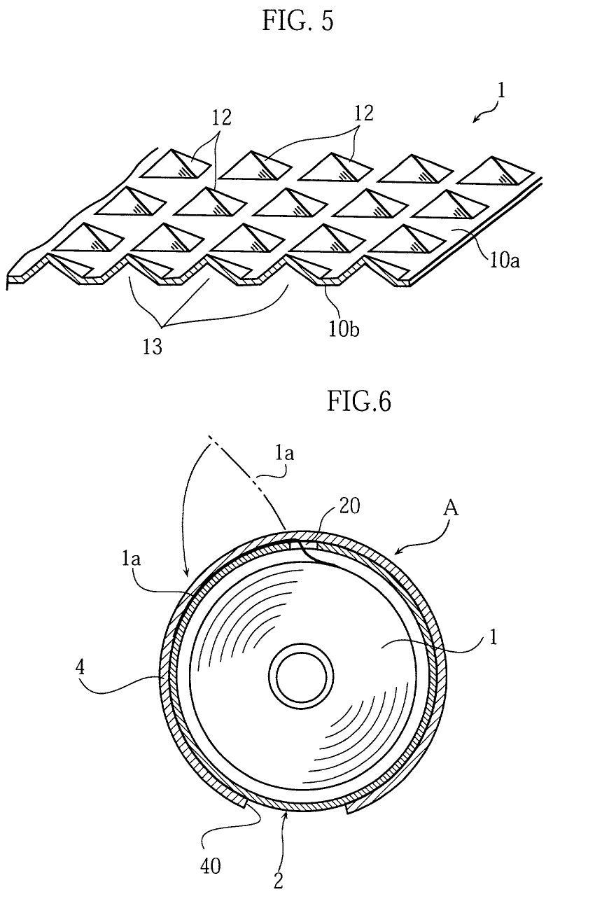

As shown in FIG. 5, the sheet 1 may be embossed to have an obverse surface 10a formed with projections 12. The reverse surface 10b is formed with depressions 13 (corresponding to the projections 12) but is otherwise smooth or planer. Such embossing may be provided over the entirety of the sheet.

Referring to FIG. 4, the inner shell 2 for rotatably accommodating the sheet roll 1 is formed of paper or synthetic resin. The inner shell 2 is substantially cylindrical and has a slit 20 extending longitudinally of the shell 2 for taking out an leading edge 1a of the sheet 1. The inner shell 2 is also open at each end 21.

An end cap 3 is removably attached to each open end 21 of the inner shell 2 for closing the inner shell 2 endwise. The end cap 3 includes a discal wall 30, an inner annular wall 31 for rotatably receiving the shaft (core) 5 of the sheet roll 1, and an outer annular wall 32 for press-fitting around the open end 21 of the inner shell 2. The slit 20 of the inner shell 2 allows diametrical reduction of the shell 2 at the open end 21, thereby facilitating the press-fitting of the end cap 3 on the open end 21 of the shell 2. Like the inner shell 2, the end cap 3 may be made of paper or synthetic resin.

In the illustrated embodiment, either one of the two end caps 3 may be removed from the inner shell 2 for replacement of the sheet roll 1. Instead, one of the end caps 3 may be unremovably attached to one open end of the inner shell 2 with use of an adhesive for example, whereas the other end cap may be rendered removable for enabling replacement of the sheet roll 1. Alternatively, one of the end caps 3 may be formed integrally with the inner shell 2 when the shell 2 is molded.

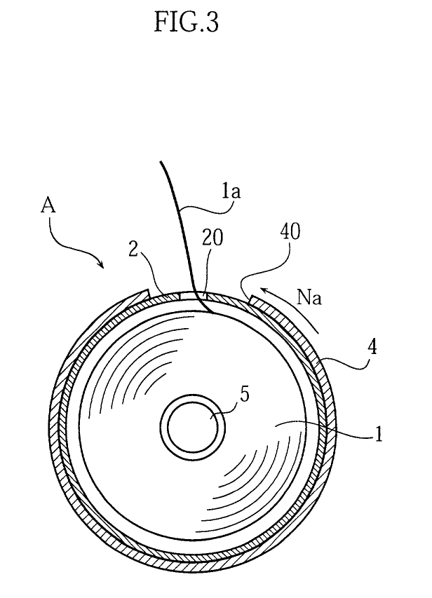

The outer sheath 4, which may be formed of paper or synthetic resin, is also substantially cylindrical and has a slit 40 which extends longitudinally of the sheath 4 and is much wider than the slit 20 of the inner shell 2, as shown in FIGS. 3 and 4. The outer sheath 4 is rotatably fitted over the inner shell 2 between the two end caps 3. The outer sheath is mounted on the cylindrical portion 20 when one of the end caps 3 is removed from the inner shell 2. The end caps 3 prevents the outer sheath 4 from being accidentally detached from the inner shell 2.

The outer sheath 4 may be loosely supported on the inner shell 2 for facilitating rotation of the sheath 4 around the inner shell 4. Alternatively, the outer sheath 4 may be press-fitted, under its own resiliency, on the inner shell 2. In this case, the outer sheath 4 does not rotate unexpectedly relative to the inner shell 2, and may be rotated around the inner shell 2 only when a rotating force is applied by a user.

The sheet dispenser A having the structure described above may be used in the following manner.

Normally, the user carries the sheet dispenser A with the sheet roll 1 housed in the inner shell 2, as shown in FIGS. 1˜3. Although the sheet is relatively long in its original state, it can be compactly wound up into a roll having a relatively small diameter. For example, a sheet having a length of 10˜90 m, a width of 10˜20 cm and a thickness of 20˜30 μm may be wound up into a roll of 15˜35 mm in diameter. Therefore, the user can conveniently carry the sheet dispenser A in a bag or pocket, for example.

If the leading edge 1a of the sheet is kept led out of the inner shell 2 through the slit 22 as shown in FIG. 3, an amount of sheet may be unintentionally paid out from the sheet roll 1 due to vibrations or external forces for example. However, such unintentional pay-out of the sheet may be prevented by rotating the outer sheath 4 relative to the inner shell 2, as indicated by an arrow Na in FIG. 3. The pay-out preventive condition is illustrated in FIG. 6 where the slit 22 is closed by the rotated outer sheath 4 with the wider slit 40 of the outer sheath 4 brought away from the narrower slit 20 of the inner shell 2. In this condition, the leading edge la of the sheet 1 is appropriately held between the outer sheath 4 and the cylindrical portion 20, so that the sheet dispenser A may be conveniently carried.

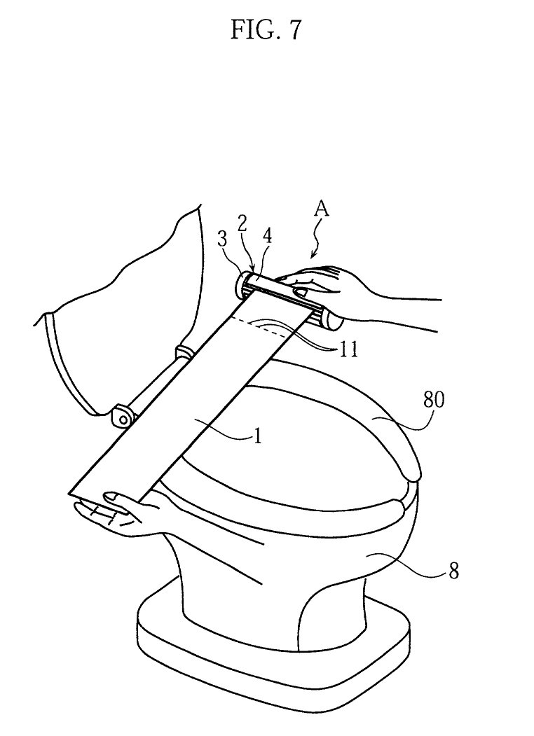

In use for covering a seat 80 of a toilet bowl 8, the outer sheath 4 is rotated relative to the inner shell (from the position shown in FIG. 6) to bring the wider slit 40 of the outer sheath 4 into alignment with the narrower slit 22 of the inner shell 2, as shown in FIG. 3. In this state, the leading edge la of the cover sheet 1 is led out from the aligned slits 20, 40, and the sheet 1 may be manually paid out from the roll through these slits as much as needed, as shown in FIG. 7.

Then, the portion of the sheet taken out from the inner shell 2 is cut off from the sheet roll 1 preferably along a tear-off line 11, there by providing a cut sheet piece 1A. The provision of the tear-off lines 11 facilitates the cutting operation. The cut sheet piece 1A is disposed to cover the seat 80.

In cutting the sheet along the tear-off lines 11, the outer sheath 4 may be diametrically compressed to press the inner shell 2 against the sheet roll 1. As a result, the sheet roll 1 is prevented from rotating relative to the inner shell 2, thereby facilitating the cutting of the sheet.

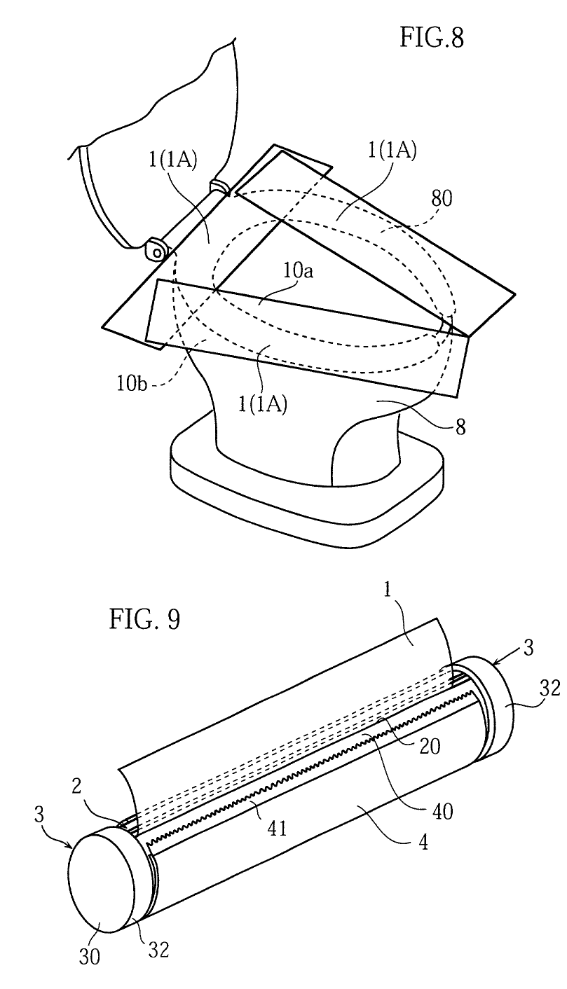

By repeating the operations described above, the toilet seat 80 is appropriately covered with a plurality of cut sheet pieces 1A, as shown in FIG. 8. Since the sheet can be cut into any desired length, the toilet seat 80 can be covered with an appropriate number of cut sheet pieces 1A entirely or almost entirely regardless of the size and shape of the toilet seat 80.

Since the sheet 1 is would up into a roll before use instead of being folded into a smaller size, each of the cut sheet pieces 1A has no trace of folds. Therefore, the sheet pieces 1A can made to conveniently follow the surface configuration of the toilet seat 80.

Further, since the sheet is formed of synthetic resin, it adheres intimately to the toilet seat 80 which is also formed of synthetic resin. The reverse surface 10b of the sheet 1 has depressions 13 (FIG. 5) by embossing but is otherwise smooth or planer. Therefore, the reverse surface 10b of each cut sheet 1A adheres intimately to the toilet seat 80 and is therefore prevented from unexpectedly sliding on the toilet seat 80.

When the user rests on the toilet seat 80 covered with the cut sheet pieces 1A, the user's hip comes into contact with the obverse surface 10a of each sheet piece 1A. At this time, since the sheet obverse surface 10a has projections 12 (FIG. 5) which provide an appropriate air layer between the user and the sheet obverse surface 10a, thereby preventing the sheet pieces 1A from adhering to the user's hips when the user stands up.

After use, since the sheet pieces 1A are water-soluble, they may be discarded into the toilet bowl 8 and flushed away with water. Since the sheet in the roll 1 is 10 to 90 m long for example, it is usable many times. When the sheet roll is exhausted, the exhausted sheet roll alone may be replaced with a new one.

The sheet 1 may be made of any water-soluble polymer material other than polyvinyl alcohol. Examples include water-soluble polymers containing carboxyl group, sulfonic group, and phosphoric acid group, or their salts. A sheet formed of resin has the advantages of reduced thickness and high barrier (resist) against contaminants. However, the sheet may contain other water-soluble material such as gelatin or cellulose as a principal material. Moreover, the sheet may have a laminated structure which includes a water-soluble paper sheet laminated on a water-soluble resin sheet for example for providing an agreeable touch.

Moreover, the case, which is formed by the combination of the inner shell 2, the end caps 3 and the outer sheath 4 according to the illustrated embodiment of the present invention, may be used for housing a roll of any sheet other than a roll of a toilet seat cover sheet.

The dispenser may be slightly modified, as shown in FIG. 9. Specifically, in the illustrated modification, the outer sheath 4 has a wider slit 40 which has one longitudinal edge provided with a saw-like cutter blade 41 for facilitating cutting of the sheet 1 particularly where the sheet 1 has no tear-off lines. The cutter blade 5 may be formed of metal or synthetic resin. Instead of the wider slit 40 of the outer sheath 4, the narrower slit 20 of the inner shell 2 may be provided with a saw-like cutter blade (not shown).

The present invention being thus described, it is obvious that the same may be modified in various ways. Such modifications should not be regarded as a departure from the spirit and scope of the present invention, and all such modifications as would be obvious to those skilled in the art are intended to be included within the scope of the following claims.

1. A toilet seat cover sheet dispenser comprising:
a roll of an elongated sheet, and
a case for rotatably housing the sheet roll, the case being formed with a slit for taking out the sheet.

2. The dispenser according to claim 1, wherein the case includes at least one end cap which is removable for inserting the sheet roll axially into the case.

3. The dispenser according to claim 1, wherein the case includes a substantially cylindrical shell formed with the slit which extends over an entire length of the shell, and a pair of end caps each press-fitted on a respective end of the shell, each said end cap being removable from the respective end of the shell for inserting the sheet roll axially into the case.

4. The dispenser according to claim 3, wherein the sheet roll includes a core shaft axially projecting beyond the roll, each said end cap having an inner annular wall rotatably receiving the core shaft of the sheet roll, each said end cap further having an outer annular wall press-fitted on the respective end of the shell.

5. The dispenser according to claim 4, wherein the case further includes a substantially cylindrical outer sheath rotatably fitted around the shell between the pair of end caps, the outer sheath being formed with a slit which is wider than the slit of the shell.

6. The dispenser according to claim 1, wherein the case includes a substantially cylindrical inner shell for rotatably accommodating the sheet roll, and a substantially cylindrical outer sheath rotatably fitted around the inner shell, the inner shell being formed with a narrower slit, the outer sheath being formed with a wider slit, the outer sheath being rotatable relative to the inner shell for bringing the wider slit of the outer sheath into and out of alignment with the narrower slit of the inner shell.

7. The dispenser according to claim 1, wherein the slit is provided with a cutting blade for cutting the sheet.

8. The dispenser according to claim 1, wherein the sheet is water-soluble.

9. The dispenser according to claim 1, wherein the sheet is formed of water-soluble resin.

10. The dispenser according to claim 1, wherein the sheet is embossed to have an obverse surface formed with projections, and a reverse surface formed with depressions.

11. The dispenser according to claim 1, wherein the sheet is formed with a plurality of perforated tear-off lines at a predetermined pitch longitudinally of the sheet.

12. A roll of an elongated toilet seat cover sheet, wherein the sheet is embossed to have an obverse surface formed with projections, and a reverse surface formed with depressions.

13. The sheet roll according to claim 12, wherein the sheet is water-soluble.

14. The sheet roll according to claim 12, wherein the sheet is formed of water-soluble resin.

15. The sheet roll according to claim 12, wherein the sheet is formed with a plurality of perforated tear-off lines at a predetermined pitch longitudinally of the sheet.

16. The sheet roll according to claim 12, further comprising a core shaft on which the sheet roll is supported, the core shaft projecting axially beyond the sheet roll.

17. A case for accommodating a roll of a sheet, the case comprising:
a substantially cylindrical inner shell for rotatably accommodating the sheet roll, and
a substantially cylindrical outer sheath rotatably fitted around the inner shell,
wherein the inner shell is formed with a narrower slit, the outer sheath being formed with a wider slit, the outer sheath being rotatable relative to the inner shell for bringing the wider slit of the outer sheath into and out of alignment with the narrower slit of the inner shell.

18. The case according to claim 17, further comprising at least one end cap attached to an end of the inner shell, the end cap being removable from the end of the inner shell for inserting the sheet roll axially into the case.

19. The case according to claim 17, further comprising a pair of end caps each removably attached to a respective end of the inner shell, the outer sheath being rotatably fitted around the inner shell between the pair of end caps.

20. The case according to claim 19, wherein the sheet roll includes a core shaft axially projecting beyond the roll, each said end cap having an inner annular wall rotatably receiving the core shaft of the sheet roll, each said end cap further having an outer annular wall press-fitted on the respective end of the shell.

21. The case according to claim 17, wherein the wider slit of the outer sheath is provided with a cutting blade for cutting the sheet.
